(19) United States
(12) Patent Application Publication
(10) Pub. No.: US 2017/0169431 A1
(43) Pub. Date: Jun. 15, 2017

(54) SYSTEMS AND METHODS FOR USING BROWSER HISTORY IN ONLINE FRAUD DETECTION

(71) Applicant: MasterCard International Incorporated, Purchase, NY (US)

(72) Inventors: Peter J. Groarke, Dublin (IE); John Allen, Dublin (IE)

(21) Appl. No.: 14/968,470

(22) Filed: Dec. 14, 2015

(51) Int. Cl. G06Q 20/40

(52) U.S. Cl. CPC G06Q 20/4016

(57) ABSTRACT

A fraud detection computing device for using browser history to detect fraudulent online cardholder activity is provided. The fraud detection computing device includes one or more processors in communication with one or more memory devices. The fraud detection computing device is configured to receive, from an interchange network, an authorization request message, identify a device identifier associated with the cardholder computing device, authenticate that the device identifier is associated with the first cardholder account, retrieve a plurality of user browser history based on the device identifier, analyze the plurality of user browser history to determine a plurality of expected pending transactions, determine whether the payment card transaction is included within the plurality of expected pending transactions, and respond to the authorization request message based at least in part on whether the payment card transaction is included within the plurality of expected pending transactions.

### BACKGROUND OF THE INVENTION

The field of the invention relates generally to fraud detection and, more particularly, to network-based systems and methods for providing improved online fraud detection by using a browser history.

Parties to payment card transactions have an interest in reducing the risk posed by fraudulent cardholder activity. Such parties may include merchants, payment processors, issuer banks, and acquirer banks. Accordingly, these parties often analyze payment card transactions to identify risks of fraudulent activity. Such analysis allows the parties to determine whether to authorize payment card purchases.

In at least some online payment card transactions, fraud detection may involve an analysis of computing devices and cardholder network information. For example, such known methods may involve the analysis of a cardholder computing device identifier, cardholder computing device software information, cardholder computing device IP addresses, and cardholder email addresses.

Cardholders often use computing devices for browsing and research prior to purchase. Prior to making an online purchase, many cardholders research an item before actually buying it online. For example, before buying a new camera, a cardholder may search through various camera manufacturers, models, and styles, before identifying a type that the cardholder prefers. A cardholder may visit several online sites discussing cameras and/or providing reviews of cameras before actually making a purchase. Accordingly, it may be desirable that systems may be capable of and configured to analyze browser history of cardholder devices that are used in subsequent purchases. Such methods and systems may improve the accuracy of fraud detection in online payment card transactions.

### BRIEF DESCRIPTION OF THE DISCLOSURE

In one aspect, a computer-implemented method for using browser history to detect fraudulent online cardholder activity is provided. The method is implemented using a fraud detection computing device in communication with one or more memory devices. The method includes receiving, from an interchange network, an authorization request message associated with a payment card transaction initiated by a cardholder using a cardholder computing device to perform the payment card transaction at an online merchant, wherein the cardholder is associated with a first cardholder account used for the payment card transaction, identifying a device identifier associated with the cardholder computing device, authenticating that the device identifier is associated with the first cardholder account, retrieving a plurality of user browser history based on the device identifier, analyzing the plurality of user browser history to determine a plurality of expected pending transactions, determining whether the payment card transaction is included within the plurality of expected pending transactions, and responding to the authorization request message based at least in part on whether the payment card transaction is included within the plurality of expected pending transactions.

In another aspect, a fraud detection computing device for using browser history to detect fraudulent online cardholder activity is provided. The fraud detection computing device includes one or more processors in communication with one or more memory devices. The fraud detection computing device is configured to receive, from an interchange network, an authorization request message associated with a payment card transaction initiated by a cardholder using a cardholder computing device to perform the payment card transaction at an online merchant, wherein the cardholder is associated with a first cardholder account used for the payment card transaction, identify a device identifier associated with the cardholder computing device, authenticate that the device identifier is associated with the first cardholder account, retrieve a plurality of user browser history based on the device identifier, analyze the plurality of user browser history to determine a plurality of expected pending transactions, determine whether the payment card transaction is included within the plurality of expected pending transactions, and respond to the authorization request message based at least in part on whether the payment card transaction is included within the plurality of expected pending transactions.

In yet another aspect, a computer-readable storage medium having computer-executable instructions embodied thereon is provided. When executed by a fraud detection computing device having one or more processors in communication with one or more memory devices, the computer-executable instructions cause the fraud detection computing device to receive, from an interchange network, an authorization request message associated with a payment card transaction initiated by a cardholder using a cardholder computing device to perform the payment card transaction at an online merchant, wherein the cardholder is associated with a first cardholder account used for the payment card transaction, identify a device identifier associated with the cardholder computing device, authenticate that the device identifier is associated with the first cardholder account, retrieve a plurality of user browser history based on the device identifier, analyze the plurality of user browser history to determine a plurality of expected pending transactions, determine whether the payment card transaction is included within the plurality of expected pending transactions, and respond to the authorization request message based at least in part on whether the payment card transaction is included within the plurality of expected pending transactions.

### BRIEF DESCRIPTION OF THE DRAWINGS

FIGS. 1-6 show example embodiments of the methods and systems described herein.

FIG. 1 is a schematic diagram illustrating an example multi-party payment card industry system for enabling fraud detection in online payment card transactions.

FIG. 2 is a simplified block diagram of a payment processing system and a fraud detection computing device in communication with other computing devices in accordance with one example embodiment of the present disclosure.

FIG. 3 is an expanded block diagram of an example embodiment of a server architecture of the payment processing system and the fraud detection computing device, and a plurality of other computing devices in accordance with one example embodiment of the present disclosure.

FIG. 4 illustrates an example configuration of a server system shown in FIGS. 2 and 3 in accordance with one example embodiment of the present disclosure.

FIG. 5 is a flowchart of an example process for using browser history to detect fraudulent online cardholder activity, performed by the fraud detection computing device of FIGS. 2 and 4, in accordance with one example embodiment of the present disclosure.

FIG. 6 is a diagram of components of one or more example computing devices that may be used in embodiments of the described systems and methods.

### DETAILED DESCRIPTION OF THE DISCLOSURE

The field of the invention relates generally to online fraud detection and, more particularly, to network-based systems and methods for retrieving and analyzing cardholder browser data to determine a risk of fraudulent transactions. Cardholders often use computing devices for browsing and research prior to actually making an online purchase.

Such browsing behavior may be useful to identify whether a particular cardholder transaction is fraudulent or not. In one example, a cardholder's sudden purchase of an unusual, expensive musical instrument may indicate that an online payment card transaction should be flagged. However, if the cardholder had been researching the musical instrument extensively, evidence of this research could suggest that the transaction is valid. Applying browser history to fraud detection could therefore improve the accuracy of detection in online payment card transactions. For example, fraud detection may be improved via analysis of cardholder computing device information, cardholder computing device software information, cardholder computing device IP addresses, and cardholder email addresses. Accordingly, methods and systems, such as those provided herein, of improving the accuracy of fraud detection in online payment card transactions are desirable.

Accordingly, the systems and methods described herein use browser history to detect fraudulent online cardholder activity. The methods and systems described herein may be implemented using computer programming or engineering techniques including computer software, firmware, hardware or any combination or subset thereof, to perform at least one of the following steps: (a) receive, from an interchange network, an authorization request message associated with a payment card transaction initiated by a cardholder using a cardholder computing device to perform the payment card transaction at an online merchant, wherein the cardholder is associated with a first cardholder account used for the payment card transaction; (b) identify a device identifier associated with the cardholder computing device; (c) authenticate that the device identifier is associated with the first cardholder account; (d) retrieve a plurality of user browser history based on the device identifier; (e) analyze the plurality of user browser history to determine a plurality of expected pending transactions; (f) determine whether the payment card transaction is included within the plurality of expected pending transactions; and (g) respond to the authorization request message based at least in part on whether the payment card transaction is included within the plurality of expected pending transactions.

By performing these steps, the systems and methods solve the problem in computer networking (and specifically in financial networking) of online fraud detection that would otherwise be unattainable. More specifically, by retrieving and analyzing cardholder browser history, the fraud detection computing device solves a problem necessarily rooted in computer networking using computer networking tools. By retrieving the cardholder browser history and identifying anticipated behavior (such as expected pending transactions), the systems described herein are configured to leverage this information to reduce fraud risk.

The fraud detection computing device receives an authorization request message from an interchange network. The authorization request message (described below) is associated with a payment card transaction initiated by a cardholder using a cardholder computing device. In other words, the cardholder uses a cardholder computing device to complete an online payment card transaction (in a card-not-present mode) with an online merchant. The cardholder is associated with a first cardholder account used for the payment card transaction.

The fraud detection computing device also identifies a device identifier associated with the cardholder computing device. In the example embodiment, the fraud detection computing device may retrieve a previously registered device “fingerprint” associated with the cardholder account. The fingerprint may represent a unique signature associated with the cardholder computing device. The fraud detection computing device therefore retrieves the identity that is expected to be used in conjunction with the cardholder accounts. The fraud detection computing device also authenticates that the device identifier is associated with the first cardholder account.

The fraud detection computing device further retrieves a plurality of user browser history based on the device identifier. In the example embodiment, the user browser history is retrieved from a third-party. The plurality of browser history may include websites previously visited by the cardholder computing device, keyword searches submitted by the cardholder computing device, previous purchases made by the cardholder computing device, and any other suitable information.

The fraud detection computing device additionally analyzes the plurality of browser history to determine a plurality of expected transactions. In other words, the fraud detection computing device parses the browser history and identifies transactions that would be expected based upon the browser history. In a first example, the fraud detection computing device parses the plurality of user browser history to identify a list of browsed products and determines the plurality of expected pending transactions based on the list of browsed products. Further, in such examples, the fraud detection computing device may determine a search frequency associated with each of the list of browsed products, score each of the plurality of expected pending transactions based on the search frequencies, and generate a scored list of browsed products based on the scoring of each of the plurality of expected pending transactions.

In a second example, the fraud detection computing device parses the plurality of user browser history to identify a list of browsed online merchants, and determines the plurality of expected pending transactions based on the list of browsed online merchants.

In a third example, the fraud detection computing device parses the plurality of user browser history to identify a list of keyword searches performed by the cardholder computing device and determines the plurality of expected pending transactions based on the list of keyword searches.

In a fourth example, the fraud detection computing device parses the plurality of user browser history to identify a list of browsed product manufacturers, and determined the plurality of expected pending transactions based on the list of browsed product manufacturers.

The fraud detection computing device also determines whether the payment card transaction is included within the plurality of expected pending transactions and responds to the authorization request message based at least in part on whether the payment card transaction is included within the plurality of expected pending transactions. In some examples, the fraud detection computing device also retrieve a fraud risk score associated with the payment card transaction from a risk based decisioning service (RBDS) and adjusts the fraud risk score based on whether the payment card transaction is included within the plurality of expected pending transactions.

The methods and systems described herein may be implemented using computer programming or engineering techniques including computer software, firmware, hardware or any combination or subset thereof, wherein the technical effects may be achieved by performing one of the following steps: (a) receiving, from an interchange network, an authorization request message associated with a payment card transaction initiated by a cardholder using a cardholder computing device to perform the payment card transaction at an online merchant, wherein the cardholder is associated with a first cardholder account used for the payment card transaction; (b) identifying a device identifier associated with the cardholder computing device; (c) authenticating that the device identifier is associated with the first cardholder account; (d) retrieving a plurality of user browser history based on the device identifier; (e) analyzing the plurality of user browser history to determine a plurality of expected pending transactions; (f) determining whether the payment card transaction is included within the plurality of expected pending transactions; (g) responding to the authorization request message based at least in part on whether the payment card transaction is included within the plurality of expected pending transactions; (h) parsing the plurality of user browser history to identify a list of browsed products; (i) determining the plurality of expected pending transactions based on the list of browsed products; (j) determining a search frequency associated with each of the list of browsed products; (k) scoring each of the plurality of expected pending transactions based on the search frequencies; (l) generating a scored list of browsed products based on the scoring of each of the plurality of expected pending transactions; (m) parsing the plurality of user browser history to identify a list of browsed online merchants; (n) determining the plurality of expected pending transactions based on the list of browsed online merchants; (o) parsing the plurality of user browser history to identify a list of keyword searches performed by the cardholder computing device; (p) determining the plurality of expected pending transactions based on the list of keyword searches; (q) retrieving a fraud risk score associated with the payment card transaction from a risk based decisioning service (RBDS); (r) adjusting the fraud risk score based on whether the payment card transaction is included within the plurality of expected pending transactions; (s) parsing the plurality of user browser history to identify a list of browsed product manufacturers; and (t) determining the plurality of expected pending transactions based on the list of browsed product manufacturers.

Described herein are computer systems such as a fraud detection computing device, a cardholder computing device, a payment network computing device, issuer computing devices, and related systems. As described herein, all such computer systems include a processor and a memory. However, the fraud detection computing device is specifically configured to carry out the steps described herein.

Further, any processor in a computer device referred to herein may also refer to one or more processors wherein the processor may be in one computing device or a plurality of computing devices acting in parallel. Additionally, any memory in a computer device referred to herein may also refer to one or more memories wherein the memories may be in one computing device or a plurality of computing devices acting in parallel.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

The systems and processes are not limited to the specific embodiments described herein. In addition, components of each system and each process can be practiced independent and separate from other components and processes described herein. Each component and process also can be used in combination with other assembly packages and processes.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transaction card can be used as a method of payment for performing a transaction.

The following detailed description illustrates embodiments of the disclosure by way of example and not by way of limitation. It is contemplated that the disclosure has general application to accessing cardholder computing device browser history and using such browser history to detect fraudulent online cardholder activity.

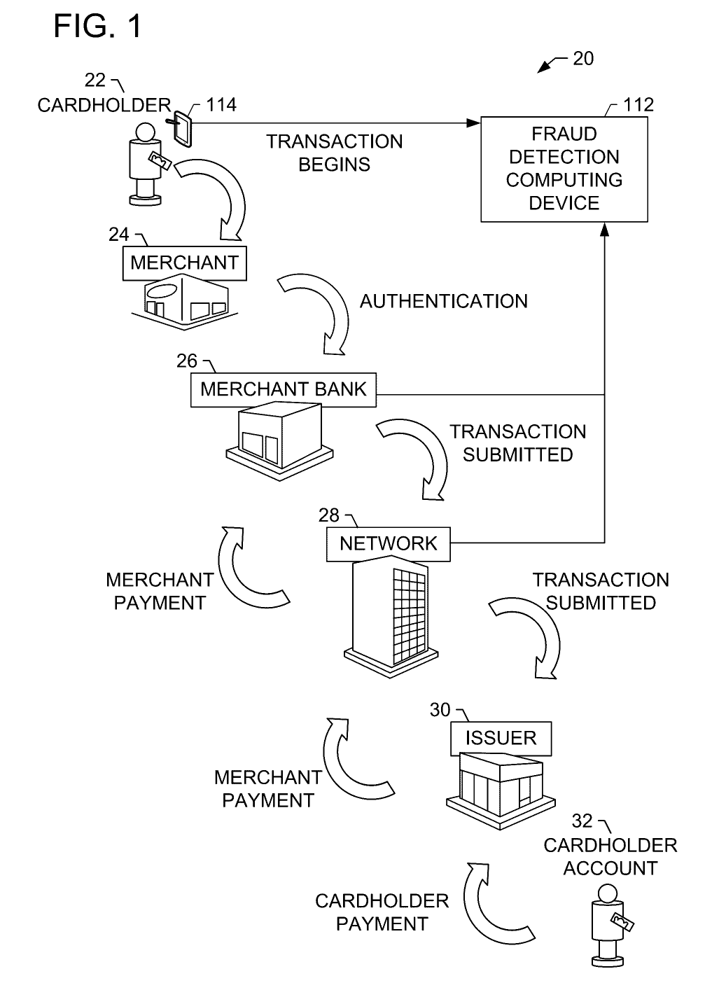

FIG. 1 is a schematic diagram illustrating an example multi-party payment card system 20 for enabling fraud detection in online payment card transactions. The present disclosure relates to payment card system 20, such as a credit card payment system using the MasterCard® payment card system payment network 28 (also referred to as an “interchange” or “interchange network”). MasterCard® payment card system payment network 28 is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In payment card system 20, a financial institution such as an issuer 30 issues a payment card for an account, such as a credit card account or a debit card account, to a cardholder 22, who uses the payment card to tender payment for a purchase from a merchant 24. To accept payment with the payment card, merchant 24 must normally establish an account with a financial institution that is part of the financial payment system. This financial institution is usually called the “merchant bank” or the “acquiring bank” or “acquirer bank” or simply “acquirer”. When a cardholder 22 tenders payment for a purchase with a payment card (also known as a financial transaction card), merchant 24 requests authorization from acquirer 26 for the amount of the purchase. Such a request is referred to herein as an authorization request message. The request may be performed over the telephone, but is usually performed through the use of a point-of-interaction terminal, also referred to herein as a point-of-sale device, which reads the cardholder's account information from the magnetic stripe on the payment card and communicates electronically with the transaction processing computers of acquirer 26. Alternatively, acquirer 26 may authorize a third party to perform transaction processing on its behalf. In this case, the point-of-interaction terminal will be configured to communicate with the third party. Such a third party is usually called a “merchant processor” or an “acquiring processor.”

Using payment card system payment network 28, the computers of acquirer 26 or the merchant processor will communicate with the computers of issuer 30, to determine whether the cardholder's account 32 is in good standing and whether the purchase is covered by the cardholder's available credit line or account balance. Based on these determinations, the request for authorization will be declined or accepted. If the request is accepted, an authorization code is issued to merchant 24.

When a request for authorization is accepted, the available credit line or available balance of cardholder's account 32 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 24 captures the transaction by, for example, appropriate data entry procedures on the point-of-interaction terminal. If a cardholder cancels a transaction before it is captured, a “void” is generated. If a cardholder returns goods after the transaction has been captured, a “credit” is generated.

For debit card transactions, when a request for authorization is approved by the issuer, the cardholder's account 32 is decreased. Normally, a charge is posted immediately to cardholder's account 32. The bankcard association then transmits the approval to the acquiring processor for distribution of goods/services, or information or cash in the case of an ATM.

After a transaction is captured, the transaction is settled between merchant 24, acquirer 26, and issuer 30. Settlement refers to the transfer of financial data or funds between the merchant's account, acquirer 26, and issuer 30 related to the transaction. Usually, transactions are captured and accumulated into a “batch,” which is settled as a group.

As described herein, fraud detection computing device 112 is in communication with payment network 28 and accordingly may receive transaction data associated with each transaction processed on payment network 28. Accordingly, fraud detection computing device 112 is configured to receive, send, and process transactions from the payment network 28.

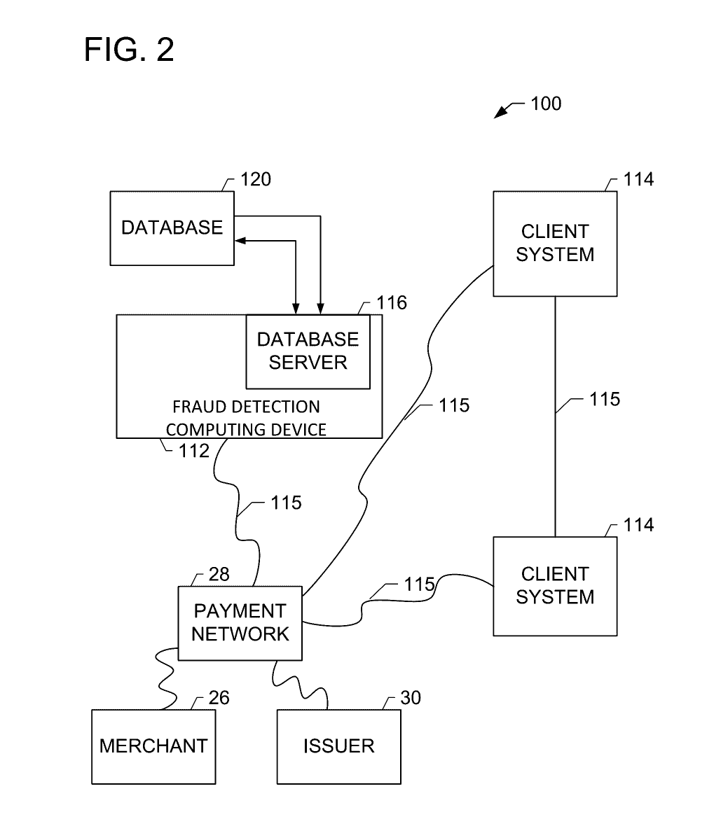

FIG. 2 is a simplified block diagram of an example computer system 100 used to provide fraud detection in accordance with the present disclosure. In the example embodiment, system 100 is used for receiving, from an interchange network, an authorization request message associated with a payment card transaction initiated by a cardholder using a cardholder computing device to perform the payment card transaction at an online merchant, wherein the cardholder is associated with a first cardholder account used for the payment card transaction, identifying a device identifier associated with the cardholder computing device, authenticating that the device identifier is associated with the first cardholder account, retrieving a plurality of user browser history based on the device identifier, analyzing the plurality of user browser history to determine a plurality of expected pending transactions, determining whether the payment card transaction is included within the plurality of expected pending transactions, and responding to the authorization request message based at least in part on whether the payment card transaction is included within the plurality of expected pending transactions, as described herein. In other embodiments, the applications may reside on other computing devices (not shown) communicatively coupled to system 100, and may perform similar functions of providing fraud detection using system 100.

More specifically, in the example embodiment, system 100 includes a fraud detection computing device 112, and a plurality of client sub-systems, also referred to as client systems 114, connected to fraud detection computing device 112. In one embodiment, client systems 114 are computers including a web browser, such that fraud detection computing device 112 is accessible to client systems 114 using the Internet. Client systems 114 may include cardholder computing devices and fraud detection computing devices 112 may retrieve browser history from such cardholder computing devices. Client systems 114 are interconnected to the Internet through many interfaces including a network 115, such as a local area network (LAN) or a wide area network (WAN), dial-in-connections, cable modems, special high-speed Integrated Services Digital Network (ISDN) lines, and RDT networks. Client systems 114 may include systems associated with cardholders 22 (shown in FIG. 1) or issuer banks. Fraud detection computing device 112 is also in communication with payment network 28 using network 115. Further, client systems 114 may additionally communicate with payment network 28 using network 115. Client systems 114 could be any device capable of interconnecting to the Internet including a web-based phone, PDA, or other web-based connectable equipment.

A database server 116 is connected to database 120, which contains information on a variety of matters, as described below in greater detail.

Database 120 may include a single database having separated sections or partitions, or may include multiple databases, each being separate from each other. Database 120 may store transaction data generated over the processing network including data relating to merchants, account holders, prospective customers, issuers, acquirers, and/or purchases made. Database 120 may also store account data including at least one of a cardholder name, a cardholder address, an account number, other account identifiers, and transaction information. Database 120 may also store merchant information including a merchant identifier that identifies each merchant registered to use the network, and instructions for settling transactions including merchant bank account information. Database 120 may also store purchase data associated with items being purchased by a cardholder from a merchant, and authorization request data.

In the example embodiment, one of client systems 114 may be associated with acquirer bank 26 (shown in FIG. 1) while another one of client systems 114 may be associated with issuer bank 30 (shown in FIG. 1). Fraud detection computing device 112 may be associated with interchange network 28. In the example embodiment, fraud detection computing device 112 is associated with a network interchange, such as interchange network 28, and may be referred to as an interchange computer system or to alternatively receive data from the interchange computer system. Fraud detection computing device 112 may be used for processing transaction data. In addition, client systems 114 may include a computer system associated with at least one of an online bank, a bill payment outsourcer, an acquirer bank, an acquirer processor, an issuer bank associated with a transaction card, an issuer processor, a remote payment system, customers and/or billers.

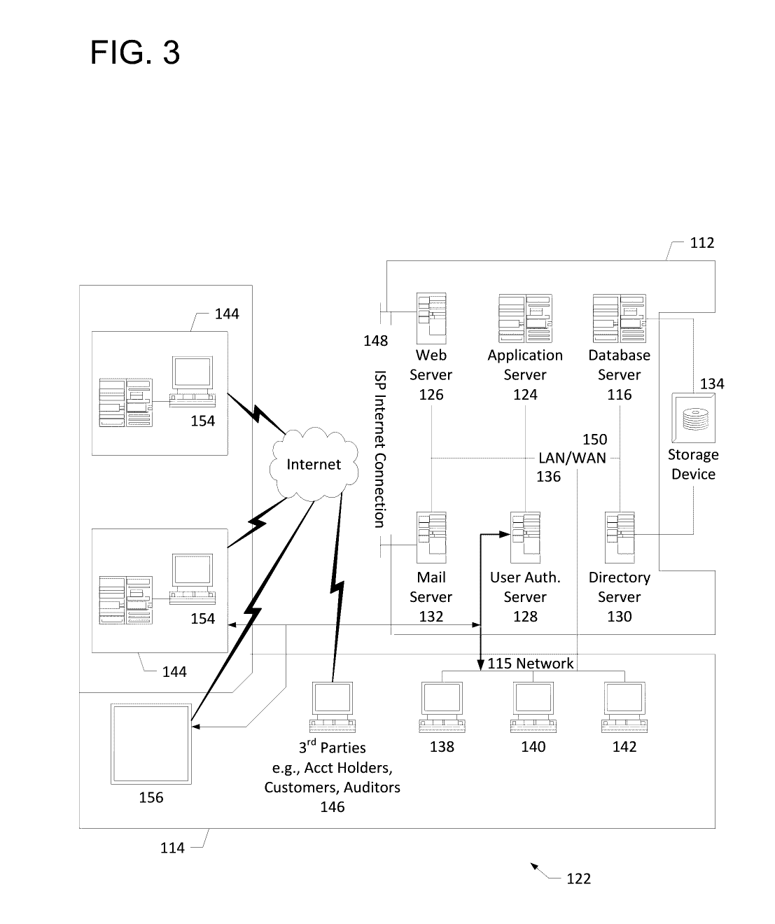

FIG. 3 is an expanded block diagram of an example embodiment of a computer server system architecture of a processing system 122 used to provide online cardholder fraud detection in accordance with one embodiment of the present disclosure. Components in system 122, identical to components of system 100 (shown in FIG. 2), are identified in FIG. 3 using the same reference numerals as used in FIG. 2. System 122 includes fraud detection computing device 112, client systems 114, and payment systems 118. Fraud detection computing device 112 further includes database server 116, a transaction server 124, a web server 126, a user authentication server 128, a directory server 130, and a mail server 132. A storage device 134 is coupled to database server 116 and directory server 130. Servers 116, 124, 126, 128, 130, and 132 are coupled in a local area network (LAN) 136. In addition, an issuer bank workstation 138, an acquirer bank workstation 140, and a third party processor workstation 142 may be coupled to LAN 136. In the example embodiment, issuer bank workstation 138, acquirer bank workstation 140, and third party processor workstation 142 are coupled to LAN 136 using network connection 115. Workstations 138, 140, and 142 are coupled to LAN 136 using an Internet link or are connected through an Intranet.

Each workstation 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Fraud detection computing device 112 is configured to be operated by various individuals including employees 144 and to third parties, e.g., account holders, customers, auditors, developers, consumers, merchants, acquirers, issuers, etc., 146 using an ISP Internet connection 148. The communication in the example embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150. Fraud detection computing device 112 is also configured to be communicatively coupled to payment systems 118. Payment systems 118 include computer systems associated with merchant bank 26, interchange network 28, issuer bank 30 (all shown in FIG. 1), and interchange network 28. Additionally, payments systems 118 may include computer systems associated with acquirer banks and processing banks. Accordingly, payment systems 118 are configured to communicate with fraud detection computing device 112 and provide transaction data as discussed below.

In the example embodiment, any authorized individual having a workstation 154 can access system 122. At least one of the client systems includes a manager workstation 156 located at a remote location. Workstations 154 and 156 are personal computers having a web browser. Also, workstations 154 and 156 are configured to communicate with fraud detection computing device 112.

Also, in the example embodiment, web server 126, application server 124, database server 116, and/or directory server 130 may host web applications, and may run on multiple server systems 112. The term “suite of applications,” as used herein, refers generally to these various web applications running on server systems 112.

Furthermore, user authentication server 128 is configured, in the example embodiment, to provide user authentication services for the suite of applications hosted by web server 126, application server 124, database server 116, and/or directory server 130. User authentication server 128 may communicate with remotely located client systems, including a client system 156. User authentication server 128 may be configured to communicate with other client systems 138, 140, and 142 as well.

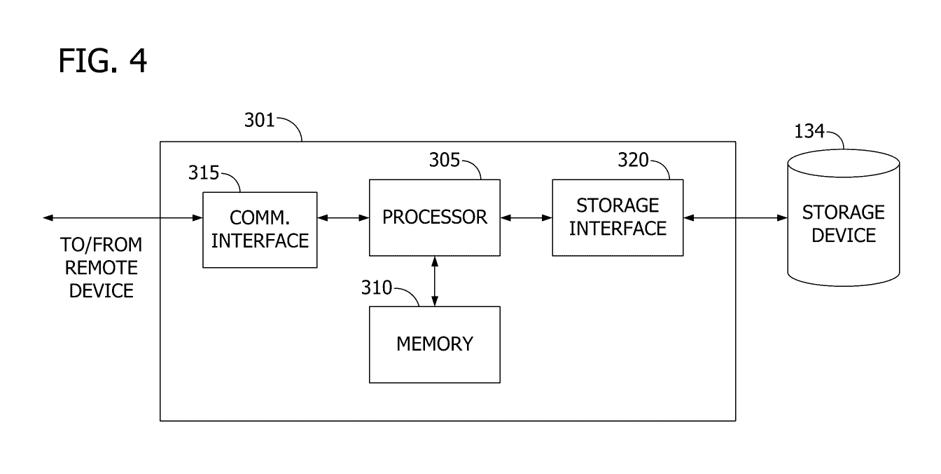

FIG. 4 illustrates an example configuration of a server system 301 such as fraud detection computing device 112 (shown in FIGS. 2 and 3). Server system 301 may include, but is not limited to, database server 116, transaction server 124, web server 126, user authentication server 128, directory server 130, and mail server 132. In the example embodiment, server system 301 determines and analyzes characteristics of devices used in payment transactions, as described below.

Server system 301 includes a processor 305 for executing instructions. Instructions may be stored in a memory area 310, for example. Processor 305 may include one or more processing units (e.g., in a multi-core configuration) for executing instructions. The instructions may be executed within a variety of different operating systems on the server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 305 is operatively coupled to a communication interface 315 such that server system 301 is capable of communicating with a remote device such as a user system or another server system 301. For example, communication interface 315 may receive requests from user system 114 via the Internet, as illustrated in FIGS. 2 and 3.

Processor 305 may also be operatively coupled to a storage device 134. Storage device 134 is any computer-operated hardware suitable for storing and/or retrieving data. In some embodiments, storage device 134 is integrated in server system 301. For example, server system 301 may include one or more hard disk drives as storage device 134. In other embodiments, storage device 134 is external to server system 301 and may be accessed by a plurality of server systems 301. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 305 is operatively coupled to storage device 134 via a storage interface 320. Storage interface 320 is any component capable of providing processor 305 with access to storage device 134. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 134.

Memory area 310 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

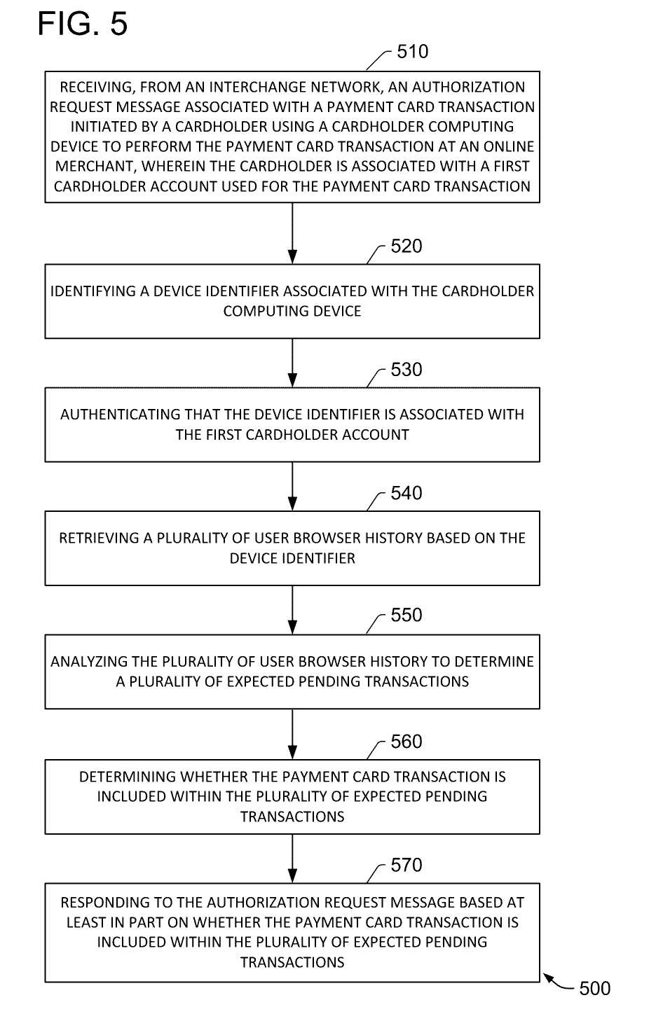

FIG. 5 is a flowchart of an example process for using browser history to detect fraudulent online cardholder activity, performed by fraud detection computing device 112 of FIGS. 2 and 4, in accordance with one example embodiment of the present disclosure. More specifically, fraud detection computing device 112 is configured to receive 510 from an interchange network 28, an authorization request message associated with a payment card transaction initiated by a cardholder using a cardholder computing device to perform the payment card transaction at an online merchant, wherein the cardholder is associated with a first cardholder account used for the payment card transaction.

Fraud detection computing device 112 is also configured to identify 520 a device identifier associated with the cardholder computing device and authenticate 530 that the device identifier is associated with the first cardholder account. Fraud detection computing device 112 is additionally configured to retrieve 540 a plurality of user browser history based on the device identifier and analyze 550 the plurality of user browser history to determine a plurality of expected pending transactions. Fraud detection computing device 112 is further configured to determine 560 whether the payment card transaction is included within the plurality of expected pending transactions and respond 570 to the authorization request message based at least in part on whether the payment card transaction is included within the plurality of expected pending transactions.

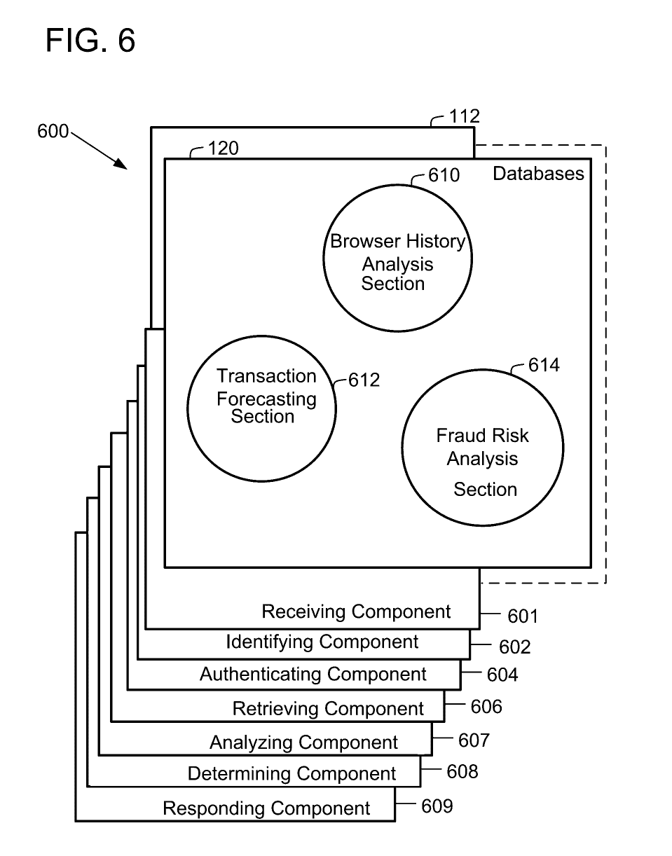

FIG. 6 is a diagram 600 of components of one or more example computing devices that may be used in the method shown in FIG. 5. FIG. 6 further shows a configuration of databases including at least database 120 (shown in FIG. 1). Database 120 is coupled to several separate components within fraud detection computing device 112, which perform specific tasks.

Fraud detection computing device 112 includes a receiving component 601 for receiving, from an interchange network, an authorization request message associated with a payment card transaction initiated by a cardholder using a cardholder computing device to perform the payment card transaction at an online merchant, wherein the cardholder is associated with a first cardholder account used for the payment card transaction. Fraud detection computing device 112 also includes an identifying component 602 for identifying a device identifier associated with the cardholder computing device. Fraud detection computing device 112 further includes an authenticating component 604 for authenticating that the device identifier is associated with the first cardholder account. Fraud detection computing device 112 additionally includes a retrieving component 606 for retrieving a plurality of user browser history based on the device identifier. Fraud detection computing device 112 further includes an analyzing component 607 for analyzing the plurality of user browser history to determine a plurality of expected pending transactions. Fraud detection computing device 112 further includes a determining component 608 for determining whether the payment card transaction is included within the plurality of expected pending transactions and a responding component 609 for responding to the authorization request message based at least in part on whether the payment card transaction is included within the plurality of expected pending transactions.

In an exemplary embodiment, database 120 is divided into a plurality of sections, including but not limited to, a browser history analysis section 610, a transaction forecasting section 612, and a fraud risk analysis section 614. These sections within database 120 are interconnected to update and retrieve the information as required.

As will be appreciated based on the foregoing specification, the above-discussed embodiments of the disclosure may be implemented using computer programming or engineering techniques including computer software, firmware, hardware or any combination or subset thereof. Any such resulting computer program, having computer-readable and/or computer-executable instructions, may be embodied or provided within one or more computer-readable media, thereby making a computer program product, i.e., an article of manufacture, according to the discussed embodiments of the disclosure. These computer programs (also known as programs, software, software applications or code) include machine instructions for a programmable processor, and can be implemented in a high-level procedural and/or object-oriented programming language, and/or in assembly/machine language. As used herein, the terms “machine-readable medium,” “computer-readable medium,” and “computer-readable media” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium,” “computer-readable medium,” and “computer-readable media,” however, do not include transitory signals (i.e., they are “non-transitory”). The term “machine-readable signal” refers to any signal used to provide machine instructions and/or data to a programmable processor.

This written description uses examples, including the best mode, to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A computer-implemented method for using browser history to detect fraudulent online cardholder activity, said method implemented using a fraud detection computing device in communication with one or more memory devices, said method comprising:
receiving, from an interchange network, an authorization request message associated with a payment card transaction initiated by a cardholder using a cardholder computing device to perform the payment card transaction at an online merchant, wherein the cardholder is associated with a first cardholder account used for the payment card transaction;
identifying a device identifier associated with the cardholder computing device;
authenticating that the device identifier is associated with the first cardholder account;
retrieving a plurality of user browser history based on the device identifier;
analyzing the plurality of user browser history to determine a plurality of expected pending transactions;
determining whether the payment card transaction is included within the plurality of expected pending transactions; and
responding to the authorization request message based at least in part on whether the payment card transaction is included within the plurality of expected pending transactions.

2. The method of claim 1, further comprising:
parsing the plurality of user browser history to identify a list of browsed products; and
determining the plurality of expected pending transactions based on the list of browsed products.

3. The method of claim 2, further comprising:
determining a search frequency associated with each of the list of browsed products;
scoring each of the plurality of expected pending transactions based on the search frequencies; and
generating a scored list of browsed products based on the scoring of each of the plurality of expected pending transactions.

4. The method of claim 1, further comprising:
parsing the plurality of user browser history to identify a list of browsed online merchants; and
determining the plurality of expected pending transactions based on the list of browsed online merchants.

5. The method of claim 1, further comprising:
parsing the plurality of user browser history to identify a list of keyword searches performed by the cardholder computing device; and
determining the plurality of expected pending transactions based on the list of keyword searches.

6. The method of claim 1, further comprising:
retrieving a fraud risk score associated with the payment card transaction from a risk based decisioning service (RBDS); and
adjusting the fraud risk score based on whether the payment card transaction is included within the plurality of expected pending transactions.

7. The method of claim 1, further comprising:
parsing the plurality of user browser history to identify a list of browsed product manufacturers; and
determining the plurality of expected pending transactions based on the list of browsed product manufacturers.

8. A fraud detection computing device for using browser history to detect fraudulent online cardholder activity, said fraud detection computing device comprising one or more processors in communication with one or more memory devices, said fraud detection computing device configured to:
receive, from an interchange network, an authorization request message associated with a payment card transaction initiated by a cardholder using a cardholder computing device to perform the payment card transaction at an online merchant, wherein the cardholder is associated with a first cardholder account used for the payment card transaction;
identify a device identifier associated with the cardholder computing device;
authenticate that the device identifier is associated with the first cardholder account;
retrieve a plurality of user browser history based on the device identifier;
analyze the plurality of user browser history to determine a plurality of expected pending transactions;
determine whether the payment card transaction is included within the plurality of expected pending transactions; and
respond to the authorization request message based at least in part on whether the payment card transaction is included within the plurality of expected pending transactions.

9. The fraud detection computing device of claim 8, said fraud detection computing device further configured to:
parse the plurality of user browser history to identify a list of browsed products; and
determine the plurality of expected pending transactions based on the list of browsed products.

10. The fraud detection computing device of claim 9, said fraud detection computing device further configured to:
determine a search frequency associated with each of the list of browsed products;
score each of the plurality of expected pending transactions based on the search frequencies; and
generate a scored list of browsed products based on the scoring of each of the plurality of expected pending transactions.

11. The fraud detection computing device of claim 8, said fraud detection computing device further configured to:
parse the plurality of user browser history to identify a list of browsed online merchants; and
determine the plurality of expected pending transactions based on the list of browsed online merchants.

12. The fraud detection computing device of claim 8, said fraud detection computing device further configured to:
parse the plurality of user browser history to identify a list of keyword searches performed by the cardholder computing device; and
determine the plurality of expected pending transactions based on the list of keyword searches.

13. The fraud detection computing device of claim 8, said fraud detection computing device further configured to:
retrieve a fraud risk score associated with the payment card transaction from a risk based decisioning service (RBDS); and
adjust the fraud risk score based on whether the payment card transaction is included within the plurality of expected pending transactions.

14. The fraud detection computing device of claim 8, said fraud detection computing device further configured to:
parse the plurality of user browser history to identify a list of browsed product manufacturers; and
determine the plurality of expected pending transactions based on the list of browsed product manufacturers.

15. A computer-readable storage medium having computer-executable instructions embodied thereon, wherein when executed by a fraud detection computing device having one or more processors in communication with one or more memory devices, the computer-executable instructions cause the fraud detection computing device to:
receive, from an interchange network, an authorization request message associated with a payment card transaction initiated by a cardholder using a cardholder computing device to perform the payment card transaction at an online merchant, wherein the cardholder is associated with a first cardholder account used for the payment card transaction;
identify a device identifier associated with the cardholder computing device;
authenticate that the device identifier is associated with the first cardholder account;
retrieve a plurality of user browser history based on the device identifier;
analyze the plurality of user browser history to determine a plurality of expected pending transactions;
determine whether the payment card transaction is included within the plurality of expected pending transactions; and
respond to the authorization request message based at least in part on whether the payment card transaction is included within the plurality of expected pending transactions.

16. The computer-readable storage medium of claim 15, wherein the computer-executable instructions additionally cause the fraud detection computing device to:
parse the plurality of user browser history to identify a list of browsed products; and
determine the plurality of expected pending transactions based on the list of browsed products.

17. The computer-readable storage medium of claim 16, wherein the computer-executable instructions additionally cause the fraud detection computing device to:
determine a search frequency associated with each of the list of browsed products;
score each of the plurality of expected pending transactions based on the search frequencies; and
generate a scored list of browsed products based on the scoring of each of the plurality of expected pending transactions.

18. The computer-readable storage medium of claim 15, wherein the computer-executable instructions additionally cause the fraud detection computing device to:
parse the plurality of user browser history to identify a list of browsed online merchants; and
determine the plurality of expected pending transactions based on the list of browsed online merchants.

19. The computer-readable storage medium of claim 15, wherein the computer-executable instructions additionally cause the fraud detection computing device to:
parse the plurality of user browser history to identify a list of keyword searches performed by the cardholder computing device; and
determine the plurality of expected pending transactions based on the list of keyword searches.

20. The computer-readable storage medium of claim 15, wherein the computer-executable instructions additionally cause the fraud detection computing device to:
parse the plurality of user browser history to identify a list of browsed product manufacturers; and
determine the plurality of expected pending transactions based on the list of browsed product manufacturers.
